(19) United States
(12) Patent Application Publication
(10) Pub. No.: US 2015/0374051 A1
(43) Pub. Date: Dec. 31, 2015

(54) PROCESS FOR MAKING CUSTOM CONFIGURED ELECTRICAL LINEMAN'S GLOVES

(71) Applicant: James B. Rauckman, (US)

(72) Inventors: James B. Rauckman, Swansea, IL (US); David W. McGuire, Jerseyville, IL (US)

(73) Assignee: James B Rauckman, Swansea, IL (US)

(21) Appl. No.: 14/769,693

(22) PCT Filed: Feb. 25, 2014
(86) PCT No.: PCT/US2014/018290

§ 371 Date: Aug. 21, 2015

Related U.S. Application Data
(60) Provisional application No. 61/783,429, filed on Mar. 14, 2013.

(51) Int. Cl. A41D 19/00; B29C 67/00; G05B 19/4099; A41D 19/015; A41D 13/008

(52) U.S. Cl. CPC A41D 19/0058; A41D 19/015; A41D 13/008; G05B 19/4099; B29C 67/0088; B33Y 10/00

(57) ABSTRACT

A process for producing an electrical rated glove configured to fit the hand of an individual, comprising the steps of making a three dimensional image of the individual's hand; using an appropriately programmed computer to create a three-dimensional model from the image; using the three-dimensional model to create, through the three dimensional printer, a 3-dimensional glove former corresponding to the 3-dimensional image of the wearer's hand; dipping the glover former in a rubber to form a rubber glove on the former corresponding to the shape to the glove former, thus corresponding to the wearer's hand. In another aspect, the process comprises making a three dimensional image of and individual's hand; constructing a mold based upon the three dimensional image of the hand; molding a glove former in the mold; and forming a rubber glove on the glove former.

### RELATED APPLICATIONS

This application claims the benefit of U.S. provisional application Ser. No. 61/783,429 filed Mar. 14, 2013, which is incorporated herein by reference.

### BACKGROUND OF THE INVENTION

The present disclosure relates to safety equipment for men working on electrical power distribution equipment. More particularly, it relates to a process for making custom configured gloves, for example electrical rated lineman's gloves.

Skilled workers who install, maintain and repair electrical distribution equipment, including transmission lines, transformers and the like, referred to herein as electrical linemen, are exposed to high voltage electric current. When working, the linemen generally employ different types of safety equipment including gloves made from electrically dielectric material. The gloves, referred to as electrical lineman gloves, help protect the lineman from injurious, even fatal, electric shocks.

A number of manufacturers produce electrically rated electrical lineman gloves, also referred to as electrical gloves. For example, Salisbury by Honeywell, Bolingbrook, Illinois, which makes natural rubber glove with rated for various maximum use voltages such as 500 AC volts, 1000 AC volts AC, 7500 AC volts, 17,500 AC volts. In general these types of electrical gloves are provided in whole and half sizes, such as size 7, 8, 10.5, 11 and so forth. In general, glove sizes are determined by measuring the circumference of the hand around the palm of the hand. It will be appreciated, however, the morphology of linemen's hands can vary and providing standard size gloves does not take into consideration variables such as the relative width of the hand, the overall thickness, the length of the fingers and other anomalies such as misshapen figures or even the absence of a finger.

It will be appreciated that a standard size 8 glove, for example, may not optimally fit the hands of all linemen who measure at a size 8. The configuration of a standard size 8 glove may not readily conform to the configuration or morphology of the wearer's hand. Wearing improperly fitting electrical gloves can affect the lineman's performance. He may not be able to optimally manipulate tools. The shape of the glove can lead to fatigue or soreness, thereby decreasing productivity.

Moreover, molds or formers used to dip mold electrical linemen's gloves generally are formed from ceramic material or metal such as aluminum. They take a substantial amount of time to produce and are expensive. Hence, they generally are provided only in standard sizes and configurations.

It would be advantageous, therefore, to be able to produce electrical rated gloves that more closely correspond to the actual configuration or morphology of the lineman's hand so as to optimize comfort, reduce soreness and fatigue and increase worker productivity.

### SUMMARY

A process for producing a glove configured to fit the hand of an individual, comprising the steps of making a three dimensional image of the individual's hand and transmitting the image to a computer; using the image to create a custom three-dimensional former design; transmitting the former design from a computer to a three dimensional printer; creating, through the three dimensional printer, a glove former corresponding to the three-dimensional former design and image; dipping the glove former in a dielectric material such as rubber to form a rubber glove on the former corresponding in size and shape of the glove former to produce a rubber glove that corresponds to the three dimensional image of the individual's hand.

In another aspect, a three dimensional image of the individual's hand is made. A cavity mold is made based upon the three dimensional image. A former is cast in the cavity mold and the former is dipped in dielectric material to form a rubber glove.

In one aspect, the cast form is a ceramic material. In another aspect, the cavity mold is oversized relative to the three dimensional image of the hand to compensate for shrinkage of the ceramic material in the cavity mold.

Another aspect is a glove made by the general process making an image of a hand; creating a glove former based upon the image of the hand; and creating a glove from the glove former.

Another aspect is a method of making a glove former.

Another aspect is a business method of providing custom configured gloves.

### BRIEF DESCRIPTION OF THE SEVERAL VIEWS OF THE DRAWINGS

FIG. 1 is a flow diagram illustrating the main steps of one aspect of the process;

FIG. 2 is a perspective view of a three-dimensional scan of a wearer's hand;

FIG. 3, is perspective view of a three-dimensional scanner operatively associated with a computer;

FIG. 4 is a perspective view of a computer with a three-dimensional drawing model;

FIG. 5 is a perspective view of a three-dimensional printer;

FIG. 6 is a perspective view of a build chamber;

FIG. 7 is a perspective view of various printed parts;

FIG. 8 is another perspective view of various printed parts;

FIG. 9 is a perspective view of a fully assembled glove former;

FIG. 10 is another perspective view of a fully assembled glove former;

FIG. 11 is a perspective view of a dip molding step using the glove former; and

FIG. 12 is a flow diagram illustrating the main steps of another aspect of the process.

### DETAILED DESCRIPTION OF THE INVENTION

While the invention is susceptible of embodiment in many different forms, there is described in detail preferred embodiments of the invention. It is to be understood that the present disclosure is to be considered only as an example of the principles of the invention. This disclosure is not intended to limit the broad aspect of the invention to the illustrated embodiments. The scope of protection extends to the broadest construction of appended claims.

The disclosure is directed to the method of making a custom configured glove. In one application, an electrical rated glove. By electrical rated, the glove, for example, can be individually tested to meet ANSI/ASTM D120 Standard and NFPA 70E for use around electrical hazards and arc flash protection. The gloves can be assigned to a class, for example Class 0, which is intended to be used in environments where the worker may be exposed to 1000-1500 AC/DC volts. Classes range from Class 00 to Class 4 (36,000 volts)(Insulating Gloves and Sleeves; Occupational Safety & Health Administration; United States Department of Labor; www.osha.gov).

The disclosure is also directed to a method of making a former used to make the glove.

The disclosure is directed to a glove made by a process comprising the steps of making an image of a hand; creating a glove former based upon the image of the hand; and creating a glove from the glove former

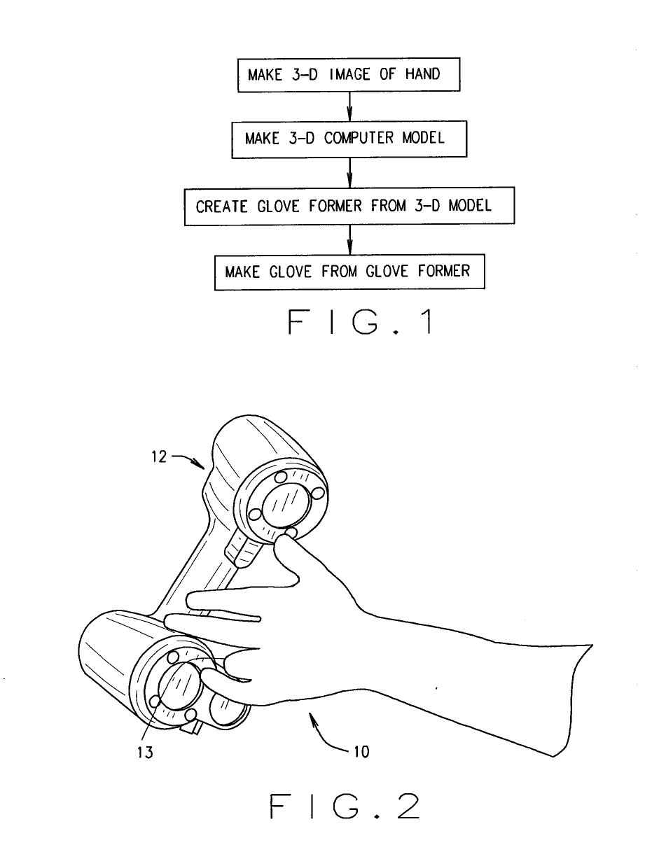

The a general process for making a custom configured glove for a wearer is set out in FIG. 1 More specifically, as shown in FIG. 2, as a first general step, a scan of the wearer's hand(s) 10 is performed. Although any type of device can be used to make a scan, a three-dimensional scanner 12 works well. One representative type of 3-dimensional scanner is a three-dimensional laser scanner provided by Creaform, Quebec, Canada. Scanner 12, as shown, is handheld and convenient to use. The scan creates a digital image of the morphology of the wearer's hand(s). For purposes of illustration it will be noted part of the wearer's right ring finger is missing, as at 13.

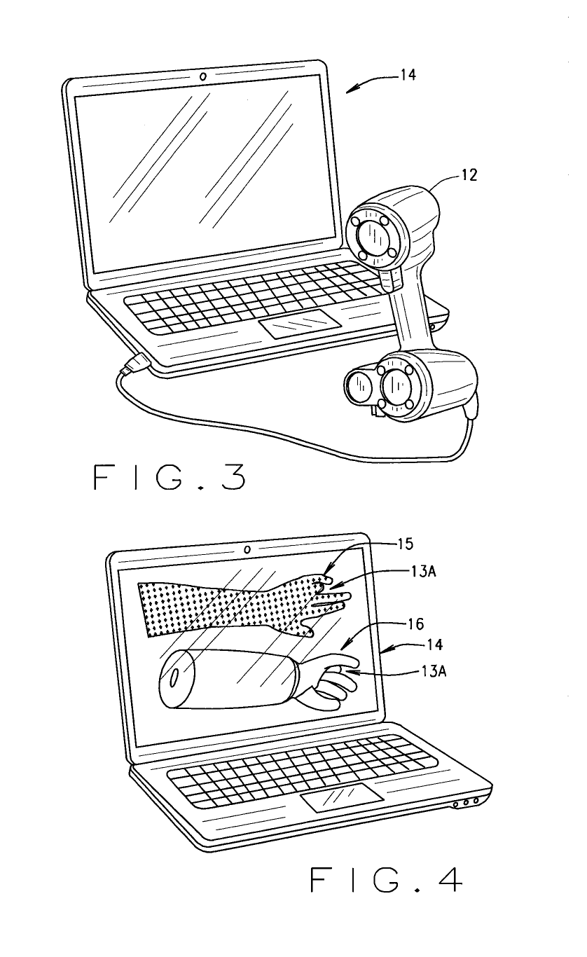

As shown in in FIG. 3, the scan is used to make a three-dimensional image. For example, the can be electronically transmitted to an appropriately programmed computer 14. The scan 15 (FIG. 4) can be transmitted directly from the scanner 12 the computer or, alternatively, the scan also can be saved on an appropriate storage device and later transmitted to a computer. For example, a producer of the custom configured gloves may have a field representative travel to the site of the wearer and perform the three-dimensional scan of the hand(s), send the scan back to a computer electronically or save the scan on a storage device for later use. Or, the scan may be made by a third party or the wearer's employer. In any event, as will be appreciated, the three-dimensional scan can replicate the morphology of the wearer's hand(s), including size, configuration, and any anomalies such as a missing finger 13 and the like.

Referring to FIG. 4, the appropriately programmed computer 14 is used to create a three-dimensional drawing 16 of a glove former incorporating the size and morphology of the wearer's hand(s). An operator can scale the three-dimensional scan up by a factor that provides clearance for the users arm and hand which becomes the base model for a former. The operator can add features such as a “Bell Cuff” which is enlarged around the forearm to accommodate clothing, such as coveralls in the winter, or a “Contour Cuff” or a “Straight Cuff”. The operator can also personalize it with the users name, signature, or other indicia the wearer might want.

Drawing 16 serves as a digital model of a glove former. The model may be created using computer aided design (CAD) or animation modeling software or any appropriate program. By way of example, such programs may include, but are not limited to, VXElements (VXScan module specifically) which goes with the three-dimensional scanner, Go!Model by RapidForm which is used to fix problems and modify the three-dimensional scan and convert it to a format that can be used by a CAD system, and

SolidWorks. From SolidWorks it goes to the ZEdit and ZPrint software from ZCorp which is used to process the model for printing. It will be appreciated that since the drawing is based on the scan, the drawing is complementary to the hand morphology, as shown by ring finger 13A. Again, the drawing may be made by the manufacturer of the glove, a third party or the wearer's employer.

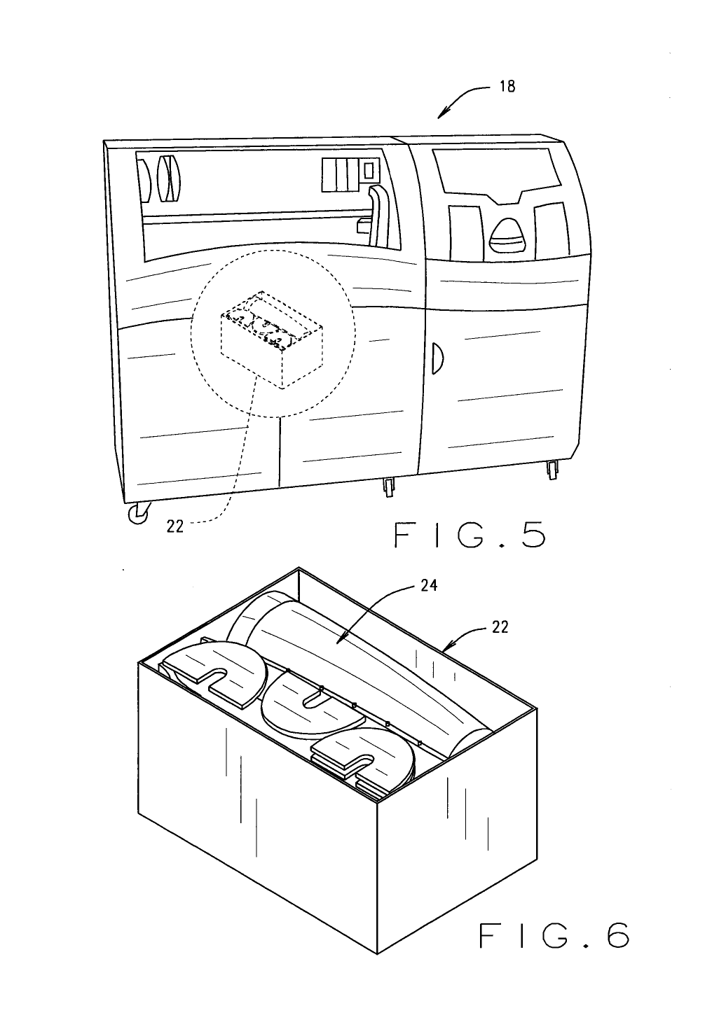

The three-dimensional drawing 16 or model of the glove is used to make a glove former. In one aspect, drawing 16 is transmitted to a three-dimensional printer 18, show in general in FIG. 5. This can be done directly from the computer software program or the drawing can be generated by the computer and then loaded on the three-dimensional printer. One example of an appropriate three-dimensional printer that employs appropriate digital technology is ZCorp ZPrinter 650. (3D Systems).

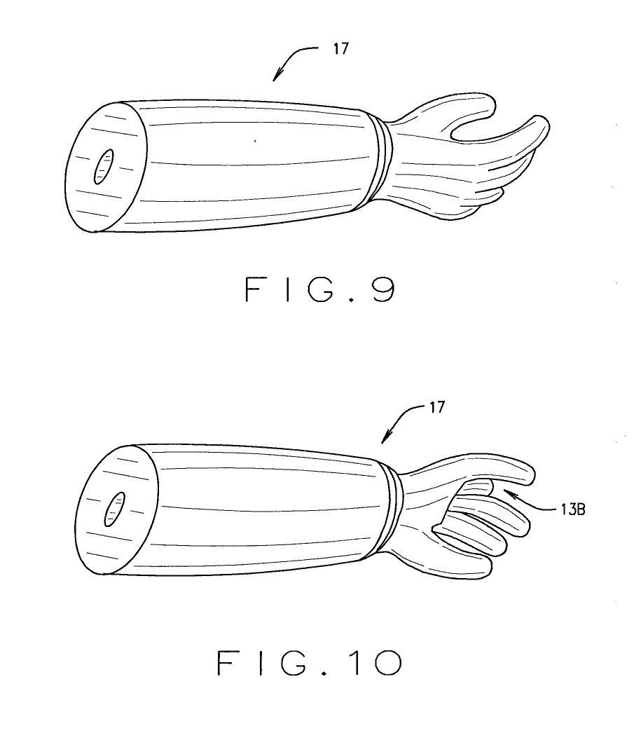

The software of the three-dimensional printer 18 slices the drawings into digital cross-sections. The three-dimensional model 16 is divided into multiple parts, as will be explained below, so they can be stacked in the printer to optimize the printing space. In any event, the three-dimensional printer is of an appropriate size and configuration to create at least one full size 3-dimensional replica of a glove former. In general, the printer reads the design from the computer software and lays down successive layers of powder with binding material or other appropriate material. The layers correspond to the cross-sections from the model. The layers are bound together with an adhesive or automatically fused to create the final shape of a glove, referred to herein as a form or a glove former 17 (FIGS. 9 and 10).

More specifically, in one aspect, printer 18 includes a box referred to as build chamber 22, which houses a build platform, also referred to as a “build bed”. The build platform is the bottom floor of box 22 which is raised and lowered by a build piston. The build platform is initially raised to the top of build chamber 22 for the first layer of powder to be spread and the cross-section of the part(s) printed, indicated generally by reference number 24 in FIGS. 5 and 6. The build piston lowers the build platform down into build chamber 22 with each successive layer, until the last layer is complete. Then build chamber 22 is vacuumed of the unused powder to reveal the completed parts for removal and finishing

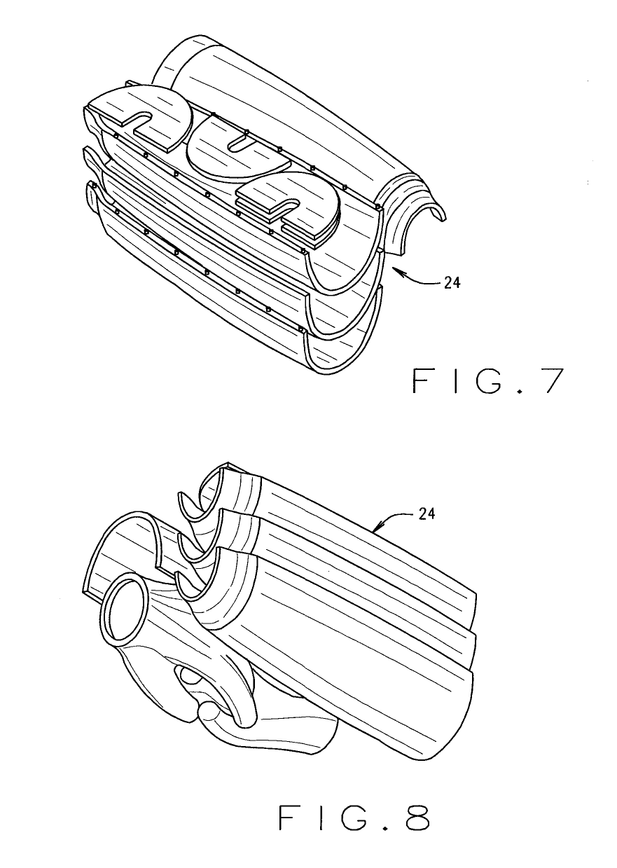

When the model is divided into parts, completed parts 24, as shown in FIGS. 7 and 8 can be assembled into a complete glove former 17, illustrated in FIGS. 9 and 10. Parts 24, as printed, can comprise any combination of parts that make up a former that optimally fit within a build chamber 22. It will be noted that, for example only, glove former 17 in FIGS. 9 and 10 is constructed with a missing right ring finger, as indicated at 13B. It will be appreciated that at this point the glove former 17 is finished in any appropriate manner 18.

For example, the glove former can be dipped in or sprayed with a coating to harden. Any appropriate sealant or hardener may be used. It can be sanded or otherwise smoothed to form a glove former suitable for dip molding. It will be noted that powder-based printers simulate the ceramic material often used for such formers, but need to be infused with an infiltration material and cured. The cured infiltration material should exhibit properties similar to the ceramic, for example, or other former materials, in order to produce a glove. The infiltrates, adhesives, and coatings should also exhibit sufficient physical qualities, including, but not limited to temperature resistance and strength, for the process.

As illustrated generally in FIG. 11, glove former 17 then is installed on an appropriate dip-molding device 26. The glove former is dipped into a bath 28 of liquid or flowable material. To make an electrical rated glove, the material is a dielectric material, such as an appropriate rubber to produce an electrical rated glove. Former 17 is withdrawn from the rubber and the material is sent through a series of processes including, but not limited to, chemical treatments, drying, curing, cleaning, testing, inspection, storage, packaging and shipping

It will be appreciated that the resulting rubber glove is electrical rated and appropriately configured to provide protection as well as optimum fit for the wearer since the glove was designed for his particular hand morphology, even compensating for a missing finger 13. The gloves, in general, are flexible and comfortable. Generally the gloves do not rub the skin or restrict hand movement.

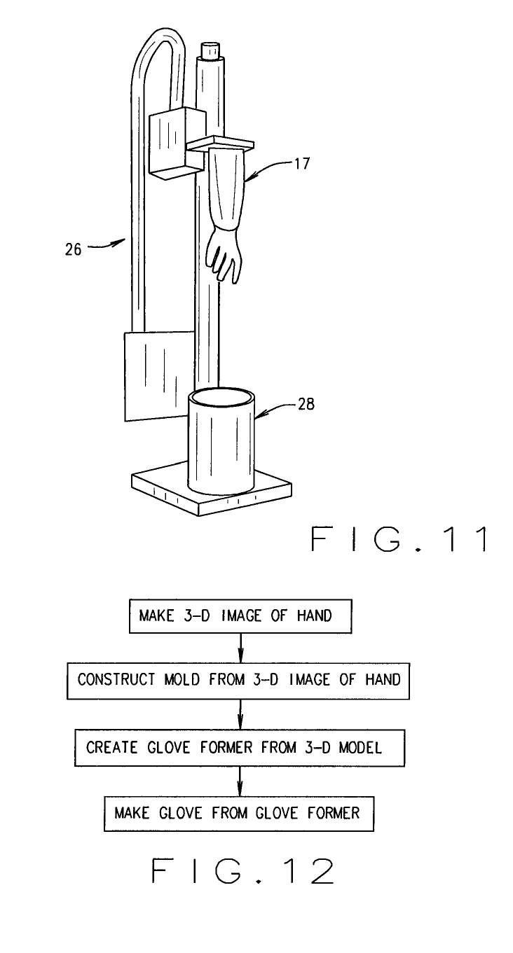

In another aspect of the process, as set out in FIG. 12, a three dimensional image of the individual's hand is made. A mold, for example a cavity mold or negative mold, is constructed based upon the three dimensional image of the hand. A glove former is cast in the cavity mold. The glove former is dipped to form a rubber glove according to steps set out above.

It will be understood in one aspect, the cast form made in the cavity mold can be molded from a clay to form a ceramic former. Depending upon the material used for the form, the cavity mold is oversized relative to the three dimensional image of the hand to compensate for shrinkage of the ceramic material in the cavity mold. For example, making the cavity mold about 10% to about 20% larger works well. In another aspect, making the cavity mold about 15% to about 20% larger works well and in another aspect, making the mold about 17% larger than the three dimensional image of the hand works well.

It will be noted that the above-described methods can be employed by a business to provide custom configured gloves for workers. By way of example, such a business can receive a request or an order for a glove designed to fit the hand of an individual; have an image made of the hand of the individual; have a glove former made based upon the image of the hand of the individual; make or have made a glove from the former; and delivering glove to the individual for use. These steps may be performed by the business or by a third party on behalf the business.

One skilled in the art will note the disclosed process is a substantial improvement over known methods of making a glove, particularly an electrical linemen's glove. The formers are substantially less expensive than ceramic formers and can be printed in a relatively short period of time. The gloves can be custom configured to accommodate difficult to fit hands to provide comfortable gloves to work in.

1. A process for producing a glove configured to fit the hand of an individual, comprising the steps of:
making an image of the individual's hand;
creating a glove former corresponding to the image of the individual's hand; and
using said glove former to make a glove.

2. The process of claim 1 wherein the step of making an image of the individual's hand further comprises making a three dimensional image of the individual's hand.

3. The process of claim 1 wherein the step of making an image of the individual's hand further comprises making a three dimensional image of the individual's hand with a 3-dimensional scanner.

4. The process of claim 1 wherein the step of creating a glove former corresponding to image of the individual's hand further comprises creating a glove former in a three dimensional printer.

5. The process of claim 1 wherein the step of using said glove former to make glove further comprises dipping the glove former in a flowable material to make an electrical rated glove.

6. The process of claim 1 wherein the step of creating a glove former further comprises creating a glove former in more than one part; and
assembling the more than one part into a glove former.

7. The process of claim 4 further comprising the step of treating the glove former with a hardener or sealant.

8. A process for producing a glove, comprising the steps of:
making a three dimensional image of the individual's hand
transmitting said image to an appropriately programmed computer to make a three-dimensional computer model;
transmitting said computer model from a computer to a three-dimensional printer;
creating, through said three dimensional printer, a glove former corresponding to said three dimensional computer model;
treating the glove former with a hardener or sealant; and
dipping said glover former in a dielectric material to form an electric rated glove on the former corresponding to the shape to the wearer's hand.

9. A process for producing glove, comprising the steps of;
making an image of an individual's hand;
constructing a mold based upon the three dimensional image of the hand;
molding a glove former in the mold; and
forming a glove on the glove former.

10. The process of claim 9 wherein the step of constructing a mold based upon the three dimensional image of the hand further comprises
constructing a mold that is oversized relative to the image of the hand.

11. The process of claim 10 wherein the mold is constructed to be about 10% to about 20% larger than the image of the hand.

12. The process of claim 10 wherein the mold is constructed to be about
15% to about 20% larger than the image of the hand.

13. A system for making an electrical rated glove comprising:
a scanner for making a 3-dimensional image of a hand;
an appropriately programmed computer for converting the 3-dimensional image of a hand into a 3-dimensional computer model of a glove;
an appropriately programmed 3-dimensional printer for printing a 3-dimensional glove former from the 3-dimensional computer model of a glove; and
apparatus for dipping the 3-dimensional glove former in a dielectric material to form an electrical rated glove on the glove former.

14. The of claim 13 further comprising apparatus for treating the glove former to harden or seal the glove former.

15. A process for making an electrical rated glove for an individual, comprising:
obtaining a glove former, said glove former having a configuration based upon an image of the individual's hand; and
creating an electrical rated glove from the glove former.

16. A glove made by a process comprising the steps of:
making an image of a hand;
creating a glove former based upon the image of the hand;
creating a glove from the glove former.

17. The glove of claim 16 wherein the glove is an electrical rated rubber glove.

18. The glove of claim 16 wherein the step of making an image of a hand further comprises making a three dimensional image of a hand.

19. The glove of claim 16 wherein the step of creating a glove former based upon the image of the hand further comprises making a glove former in a three dimensional printer.

20. The glove of claim 16 wherein the step of creating a glove former based upon the image of the hand further comprises making a glove former in mold.

21. The glove of claim 16 wherein the step of creating a glove from the glove former further comprises creating a glove by dip molding the glove former in a dielectric material.

22. The glove of claim 18 wherein the step of making a three dimensional image of a hand further comprises a step of making a three dimensional computer model of the hand.

23. A method of providing a custom made glove designed to fit the hand of an individual, comprising:
receiving a request for a glove designed to fit the hand of an individual;
having an image made of the hand of the individual;
having a glove former made based upon the image of the hand of the individual;
making a glove from the former; and
providing said glove to the individual.
